(19) United States
(12) Patent Application Publication
(10) Pub. No.: US 2022/0185373 A1
(43) Pub. Date: Jun. 16, 2022

(54) CROSS MEMBER AND VEHICLE FRAME

(71) Applicant: ISUZU MOTORS LIMITED, Shinagawa-ku, Tokyo (JP)

(72) Inventor: Kenichi HORIGUCHI, Fujisawa-shi, Kanagawa (JP)

(21) Appl. No.: 17/598,117

(22) PCT Filed: Mar. 23, 2020
(86) PCT No.: PCT/JP2020/012731

§ 371 Date: Sep. 24, 2021

(30) Foreign Application Priority Data
Mar. 26, 2019 (JP) 2019-059400

(51) Int. Cl. B62D 21/03

(52) U.S. Cl. CPC B62D 21/03

(57) ABSTRACT

A second cross member of the present invention has a cross member body that is formed in a cross-sectional crank shape and extends in the vehicle width direction, and left and right cross member gussets that are fixed to both left and right ends of the cross member body. The left and right cross member gussets are fixed to both ends parts in the vehicle width direction of a cross member upper plate part of the cross member body, and extend further toward the outside in the vehicle width direction than left and right ends of the cross member upper plate part. The distance L4 between both outside ends in the vehicle width direction of the left and right cross member gussets is greater toward both sides in the vehicle width direction than the length L2 in the vehicle width direction of the cross member body.

### TECHNICAL FIELD

The present disclosure relates to a cross member and a vehicle body frame.

### BACKGROUND ART

Patent Literature 1 discloses a cross member of a vehicle. A vehicle body frame includes a pair of left and right side members extending in a front-rear direction on both sides of the vehicle in a vehicle width direction, and a plurality of cross members extending in the vehicle width direction and connecting the left and right side members to each other. An upper plate portion of a second cross member extends in the vehicle width direction so as to intersect with an upper-lower direction, and both end portions thereof are fixed to lower surfaces of upper plate portions of the left and right side members by welding or the like. A lower plate portion of the second cross member extends in the vehicle width direction so as to intersect with the upper-lower direction, and both end portions thereof are fixed to upper surfaces of lower plate portions of the left and right side members by welding or the like. A radiator, a fan and an engine are disposed in order from a front side behind the second cross member and between the left and right side members, and are supported by the vehicle body frame.

### CITATION LIST

### Patent Literature

Patent Literature 1: JP-A-2017-119467

### SUMMARY OF INVENTION

### Technical Problem

In a vehicle in which an engine is mounted between side members of a vehicle body frame as in the vehicle disclosed in Patent Literature 1, when the engine is mounted, a heat exchanger such as a radiator and the engine are unitized in advance, and the unitized engine or the like (hereinafter, simply referred to as “engine or the like”) is mounted on the vehicle body frame while adjusting a position by being moved in the front-rear direction. In this case, between the heat exchanger located at a frontmost position of the engine or the like and a second cross member located in front of the heat exchanger (hereinafter, simply referred to as “cross member”), a given space is required to move the engine or the like in the front-rear direction. Therefore, for example, even when it is desired to dispose the heat exchanger forward in order to improve cooling performance of the heat exchanger, since the space needs to be ensured between the heat exchanger and the cross member, the heat exchanger cannot be disposed at a position close to a rear side of the cross member. In this way, in the vehicle including an in-vehicle device such as the engine mounted on the vehicle body frame while being moved in the front-rear direction, the given space needs to be ensured between the engine or the like and the cross member, and thus degree of freedom in layout around the cross member is limited.

Therefore, an object of the present disclosure is to provide a cross member and a vehicle body frame capable of improving degree of freedom in layout around the cross member.

### Solution to Problem

In order to solve the above problem, a first aspect of the present disclosure provides a cross member that is fixed to left and right side members extending in a front-rear direction on both sides of a vehicle in a vehicle width direction in a state of extending in the vehicle width direction at a given front-rear position, and connects the left and right side members to each other. The cross member includes: a cross member horizontal plate portion on an upper side; a cross member horizontal plate portion on a lower side; and a cross member vertical plate portion. The cross member horizontal plate portion on the upper side extends in the vehicle width direction in a state of intersecting with an upper-lower direction. The cross member horizontal plate portion on the lower side is disposed below the cross member horizontal plate portion on the upper side and extends in the vehicle width direction in a state of intersecting with the upper-lower direction. The cross member vertical plate portion extends in the vehicle width direction between the cross member horizontal plate portion on the upper side and the cross member horizontal plate portion on the lower side in a state of intersecting with the front-rear direction, and connects the cross member horizontal plate portion on the upper side and the cross member horizontal plate portion on the lower side. A length in the vehicle width direction of the cross member horizontal plate portion on one side in the upper-lower direction, among the cross member horizontal plate portion on the upper side and the cross member horizontal plate portion on the lower side, is longer toward both sides in the vehicle width direction than the cross member horizontal plate portion on the other side. Lengths in the vehicle width direction of the cross member horizontal plate portion on the other side and the cross member vertical plate portion are shorter than a separation distance on the one side between the left and right side members at the given front-rear position. Left and right protruding regions of the cross member horizontal plate portion on the one side, which protrude toward both sides in the vehicle width direction than the cross member horizontal plate portion on the other side, are fixed to one side surfaces of the left and right side members at the given front-rear position.

In the above configuration, the lengths in the vehicle width direction of the cross member horizontal plate portion on the other side in the upper-lower direction and the cross member vertical plate portion of the cross member at the given front-rear position are shorter than the separation distance on the one side in the upper-lower direction between the left and right side members at the given front-rear position. Therefore, when the cross member is attached to the left and right side members, the cross member horizontal plate portion on the other side (for example, the lower side) and the cross member vertical plate portion of the cross member can be inserted into a space between the left and right side members from the one side (for example, the upper side). The length in the vehicle width direction of the cross member horizontal plate portion on the one side is longer toward both sides in the vehicle width direction than the cross member horizontal plate portion on the other side, and the left and right protruding regions of the cross member horizontal plate portion on the one side, which protrude toward both sides in the vehicle width direction than the cross member horizontal plate portion on the other side, are fixed to the one side surfaces of the left and right side members at the given front and rear position. Therefore, after the cross member horizontal plate portion on the other side (for example, the lower side) and the cross member vertical plate portion are inserted into the space between the left and right side members from the one side (for example, the upper side), the left and right protruding regions of the cross member horizontal plate portion on the one side can be fixed to the one side surfaces (for example, upper surfaces) of the left and right side members. In this way, since the cross member can be attached to the left and right side members from the one side, before the cross member is attached to the left and right side members, a given in-vehicle device can be mounted so as to be close to the given front-rear position (an arrangement position of the cross member), and then the cross member can be attached to the left and right side members. Therefore, even when the in-vehicle device is mounted while being moved in the front-rear direction, it is not necessary to ensure a space for moving the in-vehicle device around (in front of or behind) the cross member, and thus degree of freedom in layout around the cross member can be improved.

A second aspect of the present disclosure provides the cross member according to the first aspect. The cross member horizontal plate portion on the upper side extends forward or rearward from an upper end edge of the cross member vertical plate portion. The cross member horizontal plate portion on the lower side extends toward a side opposite to that of the cross member horizontal plate portion on the upper side from a lower end edge of the cross member vertical plate portion.

In the above configuration, the cross member horizontal plate portion on the upper side extends forward or rearward from the upper end edge of the cross member vertical plate portion, and the cross member horizontal plate portion on the lower side extends toward the side opposite to that of the cross member horizontal plate portion on the upper side from the lower end edge of the cross member vertical plate portion. That is, since the cross member is formed in a crank shape in cross section, a rear surface or a front surface of the in-vehicle device disposed in front of or behind the cross member can be inclined. Therefore, for example, when a heat exchanger such as a radiator is disposed behind the cross member, a front surface of the heat exchanger can be inclined. Therefore, compared to a case where the front surface of the heat exchanger is erected in a vertical direction, a large area of the front surface of the heat exchanger can be ensured and cooling performance can be improved.

Since the cross member is formed in the crank shape in cross section and an upper side of the cross member horizontal plate portion on the lower side is not covered by the cross member horizontal plate portion on the upper side, the in-vehicle device can be mounted above the cross member horizontal plate portion on the lower side, and the cross member horizontal plate portion on the lower side can function as a bracket for attaching the in-vehicle device.

A third aspect of the present disclosure provides the cross member according to the first aspect or the second aspect. The cross member horizontal plate portion on the one side includes a cross member horizontal plate main body portion, and left and right cross member gussets. The cross member horizontal plate main body portion is supported by the cross member vertical plate portion and extends in the vehicle width direction between the left and right side members. The left and right cross member gussets are fixed to both left and right end portions of the cross member horizontal plate main body portion and extend outward in the vehicle width direction from both the left and right end portions of the cross member horizontal plate main body portion. The left and right protruding regions of the cross member horizontal plate portion on the one side are provided on the left and right cross member gussets.

In the above configuration, the cross member horizontal plate portion on the one side includes the cross member horizontal plate main body portion that extends in the vehicle width direction between the left and right side members, and left and right cross member gussets that are fixed to both the left and right end portions of the cross member horizontal plate main body portion. Therefore, since the length in the vehicle width direction of the cross member horizontal plate portion on the one side can be adjusted by the left and right cross member gussets, portions of the cross member excluding the left and right cross member gussets (the cross member horizontal plate main body portion of the cross member horizontal plate portion on the one side, the cross member vertical plate portion, and the cross member horizontal plate portion on the other side) can be made into common parts in various vehicles, and a manufacturing cost can be reduced.

A fourth aspect of the present disclosure provides a vehicle body frame including the cross member according to any one of the first to third aspects. Each of the left and right side members includes a side member horizontal plate portion on the upper side, a side member horizontal plate portion on the lower side, and a side member vertical plate portion. The side member horizontal plate portion on the upper side extends in the front-rear direction in a state of intersecting with the upper-lower direction. The side member horizontal plate portion on the lower side extends in the front-rear direction in a state of intersecting with the upper-lower direction below the side member horizontal plate portion on the upper side. The side member vertical plate portion extends in the front-rear direction in a state of intersecting with the vehicle width direction and connects a vehicle width direction outward end portion of the side member horizontal plate portion on the upper side and a vehicle width direction outward end portion of the side member horizontal plate portion on the lower side. A vehicle width direction inward end edge of the side member horizontal plate portion on the other side at the given front-rear position, among the side member horizontal plate portion on the upper side and the side member horizontal plate portion on the lower side of each of the left and right side members, is disposed inward in the vehicle width direction than a vehicle width direction inward end edge of the side member horizontal plate portion on the one side at the given front-rear position. A separation distance between the vehicle width direction inward end edges of the side member horizontal plate portions on the one side of the left and right side members is longer than the lengths in the vehicle width direction of the cross member horizontal plate portion on the other side and the cross member vertical plate portion and shorter than the length in the vehicle width direction of the cross member horizontal plate portion on the one side. A separation distance between the vehicle width direction inward end edges of the side member horizontal plate portions on the other side of the left and right side members is shorter than the length in the vehicle width direction of the cross member horizontal plate portion on the other side. The left and right protruding regions of the cross member horizontal plate portion on the one side are fixed to one side surfaces of the side member horizontal plate portions on the one side of the left and right side members. Both end portions in the vehicle width direction of the cross member horizontal plate portion on the other side are fixed to one side surfaces of the side member horizontal plate portions on the other side.

In the above configuration, the left and right protruding regions of the cross member horizontal plate portion on the one side are fixed to the one side surfaces of the side member horizontal plate portions on the one side of the left and right side members, and both end portions in the vehicle width direction of the cross member horizontal plate portion on the other side are fixed to the one side surfaces of the side member horizontal plate portion on the other side. That is, since the cross member horizontal plate portion on the one side and the cross member horizontal plate portion on the other side of the cross member are supported from the other side by the side member horizontal plate portions on the one side and the side member horizontal plate portions on the other side of the left and right side members, the cross member can be firmly supported by the left and right side members.

A fifth aspect of the present disclosure provides the vehicle body frame according to the fourth aspect. The side member horizontal plate portion on the other side of each of the left and right side members includes a side member horizontal plate main body portion and a side member gusset. The side member horizontal plate main body portion is supported by the side member vertical plate portion and faces the side member horizontal plate portion on the one side. The side member gusset is disposed at the given front-rear position of the side member horizontal plate main body portion, is fixed to the side member horizontal plate main body portion, and extends inward in the vehicle width direction from a vehicle width direction inward end edge of the side member horizontal plate main body portion. Both end portions in the vehicle width direction of the cross member horizontal plate portion on the other side are fixed to one side surfaces of the side member gussets of the side member horizontal plate portions on the other side of the left and right side members.

In the above configuration, the side member horizontal plate portion on the other side of each of the left and right side members includes the side member horizontal plate main body portion that faces the side member horizontal plate portion on the one side, and a side member gusset that is disposed at the given front-rear position of the side member horizontal plate main body portion and is fixed to the side member horizontal plate main body portion. Therefore, since the separation distance between the vehicle width direction inward end edges of the side member horizontal plate portion on the other side at the given front and rear position can be adjusted by the left and right side member gussets, portions of each of the left and right side members excluding the side member gusset (the side member horizontal plate portion on the one side, the side member vertical plate portion, and the side member horizontal plate main body portion of the side member horizontal plate portion on the other side) can be made into common parts in various vehicles, and a manufacturing cost can be reduced.

### Advantageous Effects of Invention

According to the present disclosure, degree of freedom in layout around the cross member can be improved.

### BRIEF DESCRIPTION OF DRAWINGS

FIG. 1 is a plan view of a front end portion of a vehicle body frame according to an embodiment of the present disclosure;

FIG. 2 is a cross-sectional view taken along a line II-II in FIG. 1;

FIG. 3 is a perspective view of the front end portion of the vehicle body frame;

FIG. 4 is a perspective view of the front end portion of the vehicle body frame in a state before a second cross member is attached.

FIG. 5 is a perspective view of the second cross member according to the embodiment of the present disclosure.

FIG. 6 is a perspective view showing a modification of the second cross member.

### DESCRIPTION OF EMBODIMENT

Hereinafter, an embodiment of the present disclosure will be described with reference to the drawings. In the drawings, FR indicates a front side of a vehicle, UP indicates an upper side of the vehicle, and IN indicates an inward side in a vehicle width direction. In the following description, a front-rear direction refers to a front-rear direction of a vehicle, and a left-right direction refers to a left-right direction in a state where the vehicle faces forward.

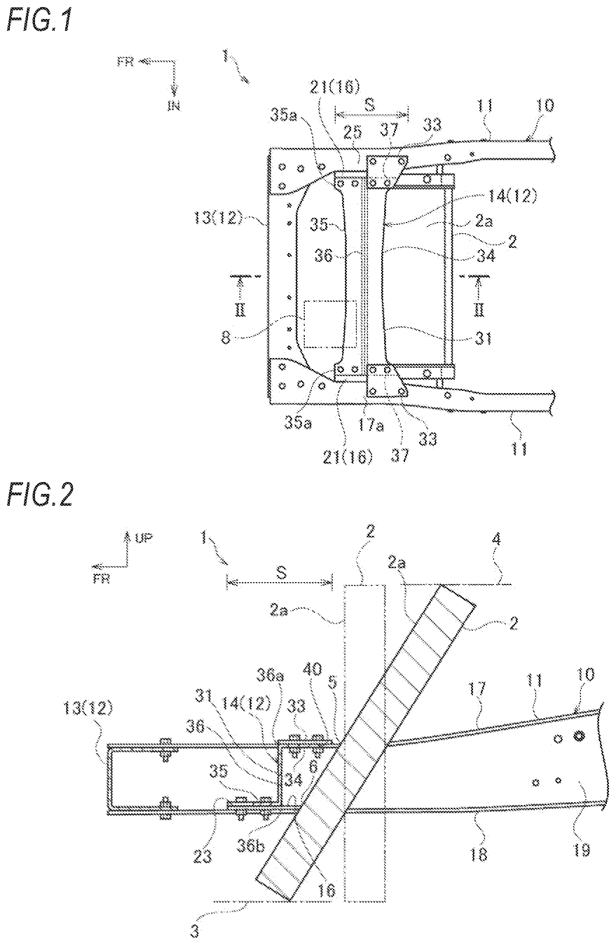

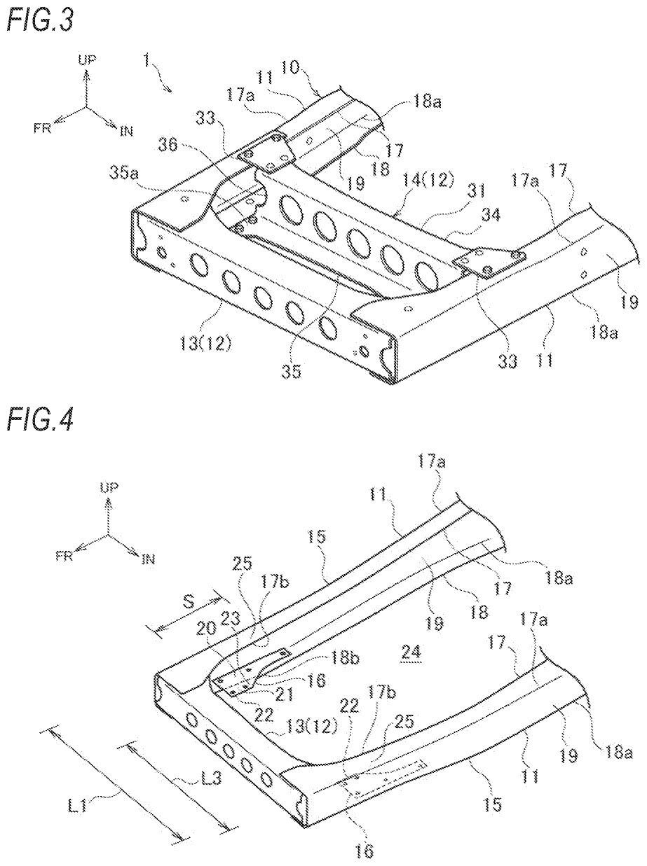

As shown in FIGS. 1 to 3, a vehicle body frame 10 according to the present embodiment is applied to a cab-over type vehicle 1 in which a cab (not shown) is disposed substantially above an engine (not shown). The cab is disposed above a front portion of the vehicle body frame 10 disposed over a front side and a rear side of the vehicle 1, and is supported by the vehicle body frame 10 from below. A radiator (heat exchanger) 2 that cools cooling water of the engine is disposed in front of the engine below the cab, and is supported by the vehicle body frame 10.

The radiator 2 is formed in a substantially plate shape intersecting with the front-rear direction, is disposed between left and right side members 11 described later of the vehicle body frame 10, and is supported by the vehicle body frame 10 in a state of being unitized with the engine. A lower end portion side of the radiator 2 is disposed forward of an upper end portion side thereof, and the radiator 2 is inclined with respect to a vertical direction. A lower end portion of the radiator 2 is disposed at a given height position (a height position indicated by a one-dot chain line 3 in FIG. 2) below the vehicle body frame 10, and an upper end portion of the radiator 2 is disposed at a given height position (a height position indicated by a one-dot chain line 4 in FIG. 2) above the vehicle body frame 10. Another heat exchanger such as an intercooler that cools intake air to the engine may be disposed on a front surface side of the radiator 2.

The vehicle body frame 10 includes a pair of left and right side members 11 extending in the front-rear direction on both sides of the vehicle 1 in the vehicle width direction, and a plurality of cross members 12 extending in the vehicle width direction and connecting the left and right side members 11 to each other, and is formed in a ladder shape by the left and right side members 11 and the plurality of cross members 12. The left and right side members 11 are each formed in a substantially U-shaped cross section that opens inward in the vehicle width direction, and extend in the front-rear direction in a state of being separated from each other in the vehicle width direction. The plurality of cross members 12 include a first cross member 13 that couples front end portions of the left and right side members 11 to each other, and a second cross member (cross member) 14 that is disposed at a given front-rear position S separated rearward from the first cross member 13. In the present embodiment, a cross member according to the present disclosure is applied to the second cross member 14. Since the left and right side members 11 are symmetrically provided on left and right sides of the vehicle 1 and have substantially the same configuration, the right side member will be described below and the left side member will be omitted.

As shown in FIG. 4, the side member 11 includes a side member main body 15 having the substantially U-shaped cross section, and a side member gusset 16 (a side member horizontal plate portion on a lower side (the other side)) fixed to the side member main body 15.

The side member main body 15 is formed by a side member upper plate portion (a side member horizontal plate portion on an upper side (one side)) 17, a side member lower plate portion (a side member horizontal plate main body portion, a side member horizontal plate portion on a lower side (the other side)) 18, and a side member side plate portion (side member vertical plate portion) 19 so as to have the substantially U-shaped cross section that opens inward in the vehicle width direction. The side member upper plate portion 17 is formed in a plate shape intersecting with the upper-lower direction, and extends elongated in the front-rear direction. The side member lower plate portion 18 is formed in a plate shape intersecting with the upper-lower direction, extends elongated in the front-rear direction at a position separated downward from the side member upper plate portion 17, and faces the side member upper plate portion 17. The side member side plate portion 19 is formed in a plate shape intersecting with the vehicle width direction, and extends elongated in the front-rear direction in a state where a vehicle width direction outward end edge portion 17a of the side member upper plate portion 17 (a vehicle width direction outward end portion of the side member horizontal plate portion on the upper side) and a vehicle width direction outward end edge portion 18a of the side member lower plate portion 18 (a vehicle width direction outward end portion of the side member horizontal plate portion on the lower side) are connected to each other. Widths (lengths in the vehicle width direction) of the side member upper plate portion 17 and the side member lower plate portion 18 at the given front-rear position S (a position where the second cross member 14 is attached) are substantially the same as each other. A vehicle width direction inward end edge 17b of the side member upper plate portion 17 (a vehicle width direction inward end edge of the side member horizontal plate portion on one side) and a vehicle width direction inward end edge 18b of the side member lower plate portion 18 (a vehicle width direction inward end edge of the side member horizontal plate main body portion) at the given front-rear position S are disposed at substantially the same vehicle width position. That is, in the present embodiment, a separation distance L1 between the vehicle width direction inward end edges 17b of the side member upper plate portions 17 of the left and right side members 11 at the given front-rear positions S is the same as a separation distance between the vehicle width direction inward end edges 18b of the side member lower plate portions 18.

The side member gusset 16 is formed in a plate shape intersecting with the upper-lower direction, is disposed at the given front-rear position S of the side member main body 15, and is fixed to the side member lower plate portion 18 in a state of being placed on an upper surface of the side member lower plate portion 18. The side member gusset 16 includes a supported region 20 that is disposed above the side member lower plate portion 18 and is supported by the side member lower plate portion 18, and a support region 21 that protrudes inward in the vehicle width direction from the vehicle width direction inward end edge 18b of the side member lower plate portion 18 and supports the second cross member 14. That is, the support region 21 of the side member gusset 16 protrudes inward in the vehicle width direction from the vehicle width direction inward end edge 17b of the side member upper plate portion 17 in a top view of the vehicle body frame 10, and a vehicle width direction inward end edge 22 of the side member gusset 16 (a vehicle width direction inward end edge of the side member horizontal plate portion on the other side) (the vehicle width direction inward end edge 22 of the support region 21) is disposed inward in the vehicle width direction from the vehicle width direction inward end edge 17b of the side member upper plate portion 17. A length in the front-rear direction of the supported region 20 is longer than a length in the front-rear direction of the support region 21. The support region 21 extends inward in the vehicle width direction from a front portion of the supported region 20.

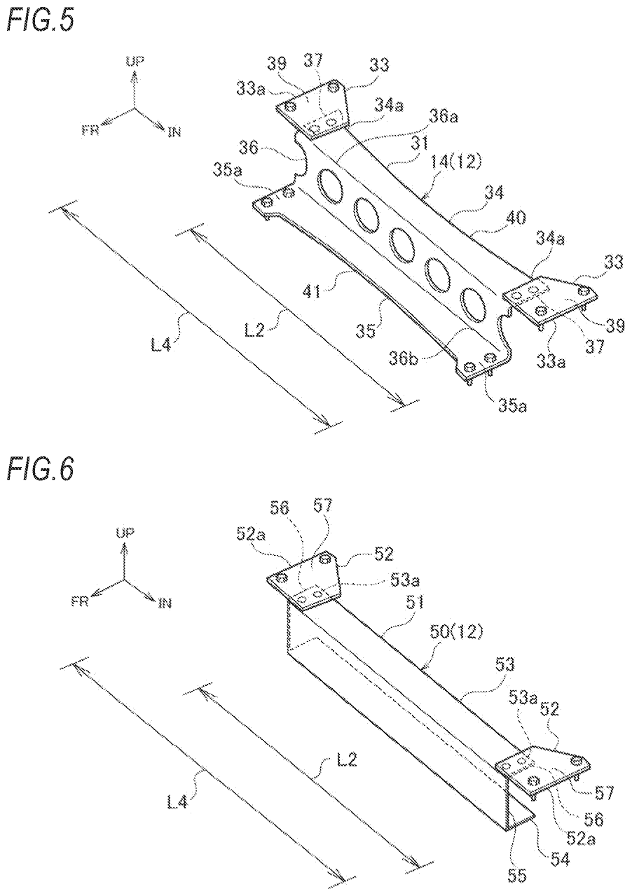

As shown in FIG. 5, the second cross member 14 includes a cross member main body 31 formed in a crank shape in cross section and extending in the vehicle width direction, and a pair of left and right cross member gussets 33 (cross member horizontal plate portions on the upper side (one side)) fixed to an upper surface of both left and right end portions of the cross member main body 31 (both end portions 34a in the vehicle width direction of a cross member upper plate portion 34 described later). A length L2 in the vehicle width direction of the cross member main body 31 is shorter than the separation distance L1 between the vehicle width direction inward end edges 17b of the side member upper plate portions 17 of the left and right side members 11 at the given front-rear positions S (see FIG. 4), and is longer than a separation distance L3 between the vehicle width direction inward end edges 22 of the side member gussets 16 of the left and right side members 11 (see FIG. 4).

The cross member main body 31 is formed in the crank shape in cross section by the cross member upper plate portion 34 (a cross member horizontal plate main body portion, a cross member horizontal plate portion on the upper side (one side)), a cross member lower plate portion 35 (a cross member horizontal plate portion on the lower side (the other side)), and a cross member middle plate portion (cross member vertical plate portion) 36. The cross member upper plate portion 34 is formed in a plate shape intersecting with the upper-lower direction, and extends elongated in the vehicle width direction. The cross member middle plate portion 36 is formed in a plate shape intersecting with the front-rear direction, is bent downward from a front end edge of the cross member upper plate portion 34, and extends elongated in the vehicle width direction in a state of standing substantially in the vertical direction. That is, the cross member upper plate portion 34 extends rearward from an upper end edge 36a of the cross member middle plate portion 36. The cross member lower plate portion 35 is formed in a plate shape intersecting with the upper-lower direction, is bent forward from a lower end edge 36b of the cross member middle plate portion 36, and extends elongated in the vehicle width direction. A rear end edge 40 of the cross member upper plate portion 34 is located rearward and upward of the lower end edge 36b of the cross member middle plate portion 36, and a front end edge 41 of the cross member lower plate portion 35 is located forward and downward of the upper end edge 36a of the cross member middle plate portion 36. The cross member upper plate portion 34, the cross member middle plate portion 36 and the cross member lower plate portion 35 have the same length L2 in the vehicle width direction, and both end edges thereof in the vehicle width direction are disposed at substantially the same vehicle width position. Both end portions 35a in the vehicle width direction of the cross member lower plate portion 35 (both end portions in the vehicle width direction of the cross member horizontal plate portion on the other side) are placed on upper surfaces 23 of the support regions 21 of the side member gussets 16 of the left and right side members 11 (see FIGS. 2 and 4), and are fixed (fastened and fixed in the present embodiment) to the support regions 21 of the side member gussets 16. A length in the upper-lower direction of the cross member middle plate portion 36 is set to a length such that, in a state where the cross member lower plate portion 35 is placed on the side member gussets 16 of the left and right side members 11, the left and right cross member gussets 33 described later come close to or come into contact with upper surfaces 25 of the side member upper plate portions 17 of the left and right side members 11 (see FIG. 4).

The left and right cross member gussets 33 are fixed (in the present embodiment, fixed by welding) to the upper surface of both end portions 34a in the vehicle width direction of the cross member upper plate portion 34 of the cross member main body 31 (both end portions in the vehicle width direction of the cross member horizontal plate main body portion), and extend outward in the vehicle width direction from both left and right ends 37 (outward ends) of the cross member upper plate portion 34 of the cross member main body 31 (both left and right ends of the cross member horizontal plate main body portion). That is, the left and right cross member gussets 33 are provided with protruding regions 39 protruding outward in the vehicle width direction from the left and right ends 37 of the cross member upper plate portion 34. A distance L4 between vehicle width direction outward ends 33a of the left and right cross member gussets 33 (the length L4 in the vehicle width direction of the cross member horizontal plate portions on the upper side (one side)) is longer toward both sides in the vehicle width direction than the length L2 in the vehicle width direction of the cross member main body 31. The distance L4 between the vehicle width direction outward ends 33a of the left and right cross member gussets 33 is longer than the separation distance L1 between the vehicle width direction inward end edges 17b of the side member upper plate portions 17 of the left and right side members 11 at the given front-rear position S. The protruding regions 39 of the left and right cross member gussets 33 are fixed (fastened and fixed in the present embodiment) to the upper surfaces 25 of the side member upper plate portions 17 of the left and right side members 11 at the given front-rear position S in a state of being placed from above.

Next, an operation of attaching the second cross member 14 to the left and right side members 11 will be described. When the second cross member 14 is attached to the left and right side members 11, first, the cross members 12 other than the second cross member 14 and the left and right side members 11 are fixed, and the vehicle body frame 10 excluding the second cross member 14 is formed in a ladder shape (see FIG. 4). Next, the engine and the unitized radiator 2 (hereafter, referred to as “radiator 2”) are disposed at a given attachment position (a position shown in FIG. 2) in a space 24 between the left and right side members 11 behind the given front-rear position S (see FIG. 4) while being moved in the front-rear direction to be fixed to the left and right side members 11. Finally, the second cross member 14 is disposed at the given front-rear position S in the space 24 between the left and right side members 11, and is fixed to the left and right side members 11.

When the second cross member 14 is fixed to the left and right side members 11, the second cross member 14 is moved downward in a state of extending in the vehicle width direction above the left and right side members 11, and the cross member lower plate portion 35 and the cross member middle plate portion 36 of the second cross member 14 are inserted from above into the space 24 between the left and right side members 11 at the given front-rear position S. When both end portions 35a in the vehicle width direction of the cross member lower plate portion 35 of the second cross member 14 come into contact with the upper surfaces 23 of the support regions 21 of the side member gussets 16 of the left and right side members 11, lower surfaces of the left and right cross member gussets 33 come close to or come into contact with the upper surfaces 25 of the side member upper plate portions 17 of the left and right side members 11. Then, both end portions 35a in the vehicle width direction of the cross member lower plate portion 35 are fixed to the upper surfaces 23 of the support regions 21 of the side member gussets 16 of the left and right side members 11, and the protruding regions 39 of the left and right cross member gussets 33 are fixed to the upper surfaces 25 of the side member upper plate portions 17 of the left and right side members 11.

As shown in FIG. 2, in a state where the second cross member 14 is attached to the left and right side members 11, a front surface 2a of the radiator 2 is inclined with respect to the vertical direction such that a lower end portion side of the radiator 2 is disposed forward of an upper end portion side behind the second cross member 14. The front surface 2a of the radiator 2 includes an upper proximity portion 5 disposed in vicinity of a rear side of the rear end edge 40 of the cross member upper plate portion 34 of the second cross member 14, and a lower proximity portion 6 disposed in vicinity of a rear side of the lower end edge 36b of the cross member middle plate portion 36 of the second cross member 14. The lower proximity portion 6 of the front surface 2a of the radiator 2 is disposed forward of the rear end edge 40 of the cross member upper plate portion 34 of the second cross member 14.

In the second cross member 14 configured as described above, the length L2 in the vehicle width direction of the cross member lower plate portion 35 and the cross member middle plate portion 36 is shorter than the separation distance L1 between the vehicle width direction inward end edges 17b of the side member upper plate portions 17 of the left and right side members 11 at the given front-rear position S. Therefore, when the second cross member 14 is fixed to the left and right side members 11, the second cross member 14 is moved downward in the state of extending in the vehicle width direction above the left and right side members 11, and the cross member lower plate portion 35 and the cross member middle plate portion 36 can be inserted from above into the given front-rear position S in the space 24 between the left and right side members 11. Since the distance L4 between the vehicle width direction outward ends 33a of the left and right cross member gussets 33 is longer than the separation distance L1 between the vehicle width direction inward end edges 17b of the side member upper plate portions 17 of the left and right side members 11 at the given front-rear position S, the protruding regions 39 of the left and right cross member gussets 33 can be fixed to the upper surfaces 25 of the side member upper plate portions 17 of the left and right side members 11. In this way, since the second cross member 14 can be attached to the left and right side members 11 from above, as described above, before the second cross member 14 is attached to the left and right side members 11, a given in-vehicle device such as the radiator 2 can be mounted so as to be close to the given front-rear position S (an arrangement position of the second cross member 14), and then the second cross member 14 can be attached to the left and right side members 11.

Therefore, even when the given in-vehicle device such as the radiator 2 is mounted while being moved in the front-rear direction, it is not necessary to ensure a space for moving the in-vehicle device around (behind in the present embodiment) the second cross member 14, and thus degree of freedom in layout around the second cross member 14 can be improved.

Since the second cross member 14 is formed in the crank shape in cross section such that the cross member upper plate portion 34 of the second cross member 14 extends rearward from the upper end edge 36a of the cross member middle plate portion 36 and the cross member lower plate portion 35 thereof extends forward from the lower end edge 36b of the cross member middle plate portion 36, the front surface 2a of the radiator 2 can be inclined with respect to the vertical direction. Therefore, compared to a case where the front surface 2a of the radiator 2 is erected in the vertical direction as indicated by a two-dot chain line in FIG. 2 between the given height position (the height position indicated by the one-dot chain line 3 in FIG. 2) below the vehicle body frame 10 and the given height position (the height position indicated by the one-dot chain line 4 in FIG. 2) above the vehicle body frame 10, a large area of the front surface 2a of the radiator 2 can be ensured and cooling performance can be improved.

Since the second cross member 14 is formed in the crank shape in cross section and an upper side of the cross member lower plate portion 35 is not covered by the cross member upper plate portion 34, when both end portions 35a in the vehicle width direction of the cross member lower plate portion 35 are fixed to the upper surfaces 23 of the support regions 21 of the side member gussets 16 of the left and right side members 11, a tool (for example, a fastening tool or a welding tool) is easily inserted above the cross member lower plate portion 35, and workability of an fixing operation is high. Since the upper side of the cross member lower plate portion 35 is not covered by the cross member upper plate portion 34, an in-vehicle device 8 (indicated by a two-dot chain line 8 in FIG. 1) can be mounted above the cross member lower plate portion 35, and the cross member lower plate portion 35 of the second cross member 14 can function as a bracket for attaching the in-vehicle device 8.

Since the second cross member 14 includes the cross member main body 31 and the left and right cross member gussets 33 fixed to the cross member main body 31, the length L2 in the vehicle width direction of the second cross member 14 on an upper side (a cross member upper plate portion 34 side) can be adjusted by the left and right cross member gussets 33. Therefore, a manufacturing cost can be reduced by using the cross member main body 31 as a common part in various vehicles (for example, vehicles having different separation distances between the left and right side members 11 or vehicles that do not require the left and right cross member gussets 33).

Both end portions 35a in the vehicle width direction of the cross member lower plate portion 35 of the second cross member 14 are fixed to the upper surfaces 23 of the support regions 21 of the side member gussets 16 of the left and right side members 11, and the protruding regions 39 of the left and right cross member gussets 33 of the second cross member 14 are fixed to the upper surfaces 25 of the side member upper plate portions 17 of the left and right side members 11. In this way, since the second cross member 14 is supported by both the side member upper plate portions 17 and the side member gussets 16 on side member lower plate portion 18 sides of the left and right side members 11, the second cross member 14 can be firmly supported by the left and right side members 11, unlike a case where the second cross member 14 is supported by only one of the side member upper plate portions 17 and the side member gussets 16 on the side member lower plate portion 18 sides.

Since the left and right side members 11 include the side member main bodies 15 and the side member gussets 16 fixed to the side member main bodies 15, the separation distance L3 between lower sides (side member lower plate portion 18 sides) of the left and right side members 11 can be adjusted by the left and right side member gussets 16. Therefore, the manufacturing cost can be reduced by using the side member main body 15 as a common part in various vehicles.

In the present embodiment, by fixing the side member gusset 16 to the side member lower plate portion 18 of each of the left and right side members 11, the side member horizontal plate portions on the lower side (the side member lower plate portion 18 and the side member gusset 16) protrude inward in the vehicle width direction than the side member horizontal plate portion on the upper side (side member upper plate portion 17). However, a shape of the side member lower plate portion 18 itself may be formed so as to protrude inward in the vehicle width direction than the side member upper plate portion 17 without providing the side member gusset 16 on each of the left and right side members 11.

In the present embodiment, the side member horizontal plate portions on the lower side (the side member lower plate portions 18 and the side member gusset 16) of each of the left and right side members 11 protrude inward in the vehicle width direction than the side member horizontal plate portion on the upper side (side member upper plate portion 17), but the side member horizontal plate portions on the lower side may not prtrude inward in the vehicle width direction than the side member horizontal plate portion on the upper side. In this case, the protruding regions 39 of the left and right cross member gussets 33 may be fixed to the upper surfaces 25 of the side member upper plate portions 17 of the left and right side members 11 without fixing the cross member lower plate portion 35 of the second cross member 14 to the left and right side members 11.

In the present embodiment, by fixing the left and right cross member gussets 33 to the cross member upper plate portion 34 of the second cross member 14, the length L4 in the vehicle width direction of the cross member horizontal plate portions on the upper side (the cross member upper plate portion 34 and the left and right cross member gussets 33) is longer toward both sides in the vehicle width direction than the length L2 in the vehicle width direction of the cross member horizontal plate portion on the lower side (cross member main body 31). However, a length in the vehicle width direction of the cross member upper plate portion 34 itself may be longer toward both sides in the vehicle width direction than the length L2 in the vehicle width direction of the cross member horizontal plate portion on the lower side (cross member main body 31) without providing the left and right cross member gussets 33 on the second cross member 14.

In the present embodiment, the cross member upper plate portion 34 of the second cross member 14 extends rearward from the upper end edge 36a of the cross member middle plate portion 36, and the cross member lower plate portion 35 thereof extends forward from the lower end edge 36b of the cross member middle plate portion 36. However, the present invention is not limited thereto, and the cross member upper plate portion 34 may extend forward from the upper end edge 36a of the cross member middle plate portion 36, and the cross member lower plate portion 35 may extend rearward from the lower end edge 36b of the cross member middle plate portion 36. Even in this case, before the second cross member 14 is attached to the left and right side members 11, the given in-vehicle device such as the radiator 2 can be mounted close to the given front-rear position S, and then the second cross member 14 can be attached to the left and right side members 11. Therefore, the degree of freedom in layout around the second cross member 14 can be improved.

In the present embodiment, the second cross member 14 is formed in the crank shape in cross section, but the present invention is not limited thereto, and the second cross member 14 may be formed in a substantially U-shaped cross section that opens forward or rearward. For example, as shown in FIG. 6, a second cross member (cross member) 50 may include a cross member main body 51 formed in a substantially U-shaped cross section that opens rearward and extending in the vehicle width direction, and a pair of left and right cross member gussets 52 (cross member horizontal plate portions on the upper side (one side)) fixed to an upper surface of both left and right end portions of the cross member main body 51. A length L2 in the vehicle width direction of the cross member main body 51 is shorter than the separation distance L1 between the vehicle width direction inward end edges 17b of the side member upper plate portions 17 of the left and right side members 11 at the given front-rear positions S (see FIG. 4), and is longer than the separation distance L3 between the vehicle width direction inward end edges 22 of the side member gussets 16 of the left and right side members 11. The cross member main body 51 is formed in the substantially U-shaped cross section by a cross member upper plate portion 53 (a cross member horizontal plate main body portion, a cross member horizontal plate portion on the upper side (one side)), a cross member lower plate portion 54 (a cross member horizontal plate portion on the lower side (the other side)), and a cross member middle plate portion (cross member vertical plate portion) 55. The cross member upper plate portion 53 is formed in a plate shape intersecting with the upper-lower direction, and extends elongated in the vehicle width direction. The cross member middle plate portion 55 is formed in a plate shape intersecting with the front-rear direction, is bent downward from a front end edge of the cross member upper plate portion 53, and extends elongated in the vehicle width direction in a state of standing substantially in the vertical direction. The cross member lower plate portion 54 is formed in a plate shape intersecting with the upper-lower direction, is bent rearward from a lower end edge of the cross member middle plate portion 55, and extends elongated in the vehicle width direction. The cross member upper plate portion 53, the cross member middle plate portion 55 and the cross member lower plate portion 54 have the same length L2 in the vehicle width direction, and both end edges thereof in the vehicle width direction are disposed at substantially the same vehicle width position. The left and right cross member gussets 52 are fixed to an upper surface of both end portions 53a in the vehicle width direction of the cross member upper plate portion 53 (both end portions in the vehicle width direction of the cross member horizontal plate main body portion). The left and right cross member gussets 52 extend outward in the vehicle width direction from both left and right ends 56 (outward ends) of the cross member upper plate portion 53 (both left and right ends of the cross member horizontal plate main body portion). That is, the left and right cross member gussets 52 are provided with protruding regions 57 protruding outward in the vehicle width direction from the left and right ends 56 of the cross member upper plate portion 53. A distance L4 between vehicle width direction outward ends 52a of the left and right cross member gussets 52 (the length L4 in the vehicle width direction of the cross member horizontal plate portion on the upper side (one side)) is longer toward both sides in the vehicle width direction than the length L2 in the vehicle width direction of the cross member main body 51. The distance L4 between the vehicle width direction outward ends 52a of the left and right cross member gussets 52 is longer than the separation distance L1 between the vehicle width direction inward end edges 17b of the side member upper plate portions 17 of the left and right side members 11 at the given front-rear position S (see FIG. 4). The protruding regions 57 of the left and right cross member gussets 52 are fixed (fastened and fixed in the present embodiment) to the upper surfaces 25 of the side member upper plate portions 17 of the left and right side members 11 at the given front-rear position S in a state of being placed from above. Even in this case, before the second cross member 50 is attached to the left and right side members 11, a given in-vehicle device such as the radiator 2 can be mounted close to the given front-rear position S, and then the second cross member 50 can be attached to the left and right side members 11. Therefore, degree of freedom in layout around the second cross member 50 can be improved. A length in the vehicle width direction of the cross member upper plate portion 53 itself may be longer toward both sides in the vehicle width direction than the length L2 in the vehicle width direction of the cross member middle plate portion 55 and the cross member lower plate portion 54 without fixing the left and right cross member gussets 52 to the cross member upper plate portion 53, and may be longer than the separation distance L1 between the vehicle width direction inward end edges 17b of the side member upper plate portions 17 of the left and right side members 11 at the given front-rear position S.

Although the present disclosure has been described above based on the above embodiment, the present disclosure is not limited to the contents of the above embodiment, and can be appropriately changed without departing from the present disclosure as a matter of course. That is, other embodiments, examples, operation techniques or the like made by those skilled in the art based on this embodiment are all included in the scope of the present disclosure.

For example, in the above embodiment, one side in the upper-lower direction in the present disclosure is referred to as an upper side, and the other side in the upper-lower direction is referred to as a lower side. However, one side in upper-lower direction may be referred to as the lower side, and the other side in the upper-lower direction may be referred to as the upper side. In this case, by fixing the side member gusset 16 of each of the left and right side member 11 to the side member upper plate portion 17, the side member upper plate portion 17 may function as the side member horizontal plate main body portion, and the side member gusset 16 and the side member upper plate portion 17 may function as the side member horizontal plate portions on the upper side (the other side). By fixing the left and right cross member gussets 33, 52 of the second cross member 14, 50 to the cross member lower plate portions 35, 54, the cross member lower plate portions 35, 54 may function as the cross member horizontal plate main body portions, and the left and right cross member gussets 33, 52 and the cross member lower plate portions 35, 54 may function as the cross member horizontal plate portions on the lower side (one side). When the second cross members 14, 50 are fixed to the left and right side members 11, the second cross members 14, 50 are moved upward in a state of being extending in the vehicle width direction below the left and right side members 11, and are fixed to the left and right side members 11.

In the above embodiment, the cross member according to the present disclosure is applied to the second cross member 14, 50 disposed second in order from a front side among the plurality of cross members 12, but may be applied to a cross member 12 other than the second cross members 14, 50.

The present application is based on Japanese Patent Application No. 2019-059400 filed on Mar. 26, 2019, contents of which are incorporated herein as reference.

### INDUSTRIAL APPLICABILITY

The cross member and the vehicle body frame according to the present disclosure can be widely applied to a vehicle including a ladder-shaped vehicle body frame.

### REFERENCE SIGNS LIST

1 vehicle
10 vehicle body frame
11 pair of left and right side members
14, 50 second cross member (cross member)
16 side member gusset (side member horizontal plate portion on lower side (the other side))
17 side member upper plate portion (side member horizontal plate portion on upper side (one side))
18 side member lower plate portion (side member horizontal plate main body portion, side member horizontal plate portion on lower side (the other side))
19 side member side plate portion (side member vertical plate portion)
33, 52 pair of left and right cross member gussets (cross member horizontal plate portion on upper side (one side))
34, 53 cross member upper plate portion (cross member horizontal plate main body portion, cross member horizontal plate portion on upper side (one side))
35, 54 cross member lower plate portion (cross member horizontal plate portion on lower side (the other side))
36, 55 cross member middle plate portion (cross member vertical plate portion)
39, 57 protruding region

1. A cross member that is to be fixed to left and right side members extending in a front-rear direction and being disposed at left and right sides of a vehicle in a vehicle width direction in a state of extending in the vehicle width direction at a given front-rear position, and connects the left and right side members to each other, the cross member comprising:
a cross member upper side plate portion which extends in the vehicle width direction in a state of intersecting with an upper-lower direction of the vehicle;
a cross member lower side plate portion which is disposed below the cross member upper side plate portion and extends in the vehicle width direction in a state of intersecting with the upper-lower direction; and
a cross member vertical plate portion that extends in the vehicle width direction between the cross member upper side plate portion and the cross member lower side plate portion in a state of intersecting with the front-rear direction, and connects the cross member upper side plate portion and the cross member lower side plate portion,
wherein a length in the vehicle width direction of one of the cross member upper side plate portion and the cross member lower side plate portion is longer than in the vehicle width direction of the other of the cross member upper side plate portion and the cross member lower side plate portion,
wherein lengths in the vehicle width direction of the other of the cross member upper side plate portion and the cross member lower side plate portion and a length in the vehicle width direction of the cross member vertical plate portion are shorter than a distance between the left and right side members at the given front-rear position, and
wherein left and right protruding regions of the one of the cross member lower side plate portion and the cross member upper plate portion which protrude outward in the vehicle width direction than the other of the cross member lower side plate portion and the cross member upper plate portion are fixed to one side surfaces of the left and right side members at the given front-rear position.

2. The cross member according to claim 1,
wherein the cross member upper side plate portion extends forward or rearward from an upper end edge of the cross member vertical plate portion, and
wherein the cross member lower side plate portion extends toward a side opposite to that of the cross member upper side plate portion from a lower end edge of the cross member vertical plate portion.

3. The cross member according to claim 1,
wherein the one of the cross member lower side plate portion and the cross member upper side plate portion includes:
a cross member main body portion that is supported by the cross member vertical plate portion and extends in the vehicle width direction between the left and right side members; and
left and right cross member gussets that are fixed to corresponding left and right end portions of the cross member main body portion and extend outward in the vehicle width direction from the left and right end portions of the cross member main body portion, and
wherein left and right protruding regions of the one of the cross member lower side plate portion and the cross member upper side plate portion are provided on the left and right cross member gussets.

4. A vehicle body frame comprising: the cross member according to claim 1,
wherein each of the left and right side members includes:
a side member upper side plate portion which extends in the front-rear direction in a state of intersecting with the upper-lower direction;
a side member lower side plate portion which extends in the front-rear direction in a state of intersecting with the upper-lower direction and is disposed below the side member upper side plate portion; and
a side member vertical plate portion that extends in the front-rear direction in a state of intersecting with the vehicle width direction and connects a vehicle width direction outward end portion of the side member upper side plate portion and a vehicle width direction outward end portion of the side member lower side plate portion,
wherein a vehicle width direction inward end edge of the other of the side member upper side plate portion and the side member lower side plate portion at the given front-rear position is disposed inward in the vehicle width direction than a vehicle width direction inward end edge of one of the side member upper side plate portion and the side member lower side plate portion at the given front-rear position,
wherein a separation distance between the vehicle width direction inward end edges of the one of the side member upper side plate portions and the side member lower side plate portions in the left and right side members is longer than the lengths in the vehicle width direction of the other of the cross member upper side plate portion and the cross member lower side plate portion and the length in the vehicle width direction of the cross member vertical plate portion and shorter than the length in the vehicle width direction of the one of the cross member upper side plate portion and the cross member lower side plate portion,
wherein a separation distance between the vehicle width direction inward end edges of the other of the side member upper side plate portions and the side member lower side plate portion of the left and right side members is shorter than the length in the vehicle width direction of the other of the cross member upper side plate portion and the cross member lower side plate portion,
wherein the left and right protruding regions of the one of the cross member upper side plate portion and the cross member lower side plate portion are fixed to one side surfaces of the one of the side member upper side plate portions and the other of the side member lower side members of the left and right side members, and
wherein both end portions in the vehicle width direction of the one of the cross member upper side plate portion and the cross member lower side plate portion are fixed to one side surfaces of the one of the side member upper side plate portions and the side member lower side plate portions.

5. The vehicle body frame according to claim 4,
wherein the other of the side member upper side plate portion and the side member lower side plate portion of each of the left and right side members includes:
a side member main body portion that is supported by the side member vertical plate portion and faces the one of the side member upper side plate portion and the side member lower side plate portion; and
a side member gusset that is disposed at the given front-rear position of the side member main body portion, is fixed to the side member main body portion, and protrudes inward in the vehicle width direction than a vehicle width direction inward end edge of the side member main body portion, and
wherein both end portions in the vehicle width direction of the other of the cross member upper side plate portion and the cross member lower side plate portion are fixed to one side surfaces of the side member gussets of the other of the side member upper side plate portions and the side member lower side plate portion of the left and right side members.
